(19) United States
(12) Patent Application Publication
(10) Pub. No.: US 2026/0352257 A1
(43) Pub. Date: Nov. 5, 2026

(54) PULSE INTERVAL ENCODING BASED INDEX MODULATION METHODS FOR PASSIVE INTERNET OF THINGS

(71) Applicant: ZTE CORPORATION, Shenzhen, Guangdong (CN)

(72) Inventors: Yihua MA, Shenzhen, Guangdong (CN); Zhifeng YUAN, Shenzhen, Guangdong (CN); Bo DAI, Shenzhen, Guangdong (CN); Kun LIU, Shenzhen, Guangdong (CN)

(21) Appl. No.: 19/487,670

(22) PCT Filed: Jun. 2, 2023
(86) PCT No.: PCT/CN2023/098115

§ 371 Date: Nov. 25, 2025

(51) Int. Cl. H04B 1/7163; H04L 25/49

(52) U.S. Cl. CPC H04B 1/71632; H04L 25/4902; H04B 2201/7163

(57) ABSTRACT

A wireless communication method for use in a first node is disclosed. The method comprises modulating at least one data bit to generate at least one symbol, wherein each symbol is one of a plurality of pulse-interval encoding (PIE) index modulation (IM) symbols, and transmitting, to a second node, the at least one symbol corresponding to the at least one data bit, wherein each PIE-IM symbol comprises a same plurality of PIE symbols, and the PIE symbols have a plurality of different pulse widths.

### CROSS-REFERENCES TO RELATED APPLICATIONS

This application is a U.S. National Phase application of International Application No. PCT/CN2023/098115, filed on Jun. 2, 2023. The disclosure of the above-mentioned application is incorporated herein by reference in its entirety.

### TECHNICAL FIELD

This document is directed generally to wireless communications, and in particular to 5G communications and more particular to 6G communications.

### BACKGROUND

The 6G system is expected to connect a vast number of IoT (Internet-of-Things) devices. To make the IoT devices widespread and convenient, the cost and power of the IoT devices need to be reduced.

### SUMMARY

This document relates to methods, systems, and devices for communications of IoT devices, and in particular to methods, systems, and devices for communications of passive IoT devices.

The present disclosure relates to a wireless communication method for use in a first node, the method comprising:
modulating at least one data bit to generate at least one symbol, wherein each symbol is one of a plurality of pulse-interval encoding (PIE) index modulation (IM) symbols, and
transmitting, to a second node, the at least one symbol corresponding to the at least one data bit.

Various embodiments may preferably implement the following features:

Preferably, each PIE-IM symbol comprises a same plurality of PIE symbols.

Preferably, the PIE symbols have a plurality of different pulse widths.

Preferably, at least one of the plurality of PIM-IM symbols is configured to indicate non-data information.

Preferably, the non-data information comprises at least one of: a start of reading, an end of reading, a start of writing, or an end of writing.

Preferably, at least one of the plurality of PIM-IM symbols is configured to indicate non-data information is forbidden to be used.

Preferably, the plurality of PIE symbols consists of at least one first PIE symbol with a first pulse width and at least one second PIE symbol with a second pulse width greater than the first pulse width.

Preferably, each PIE-IM symbol comprises only one second PIE symbol.

Preferably, information indicated by the PIE-IM symbol is determined based on a position of the second PIE symbol in the PIM-IM symbol.

Preferably, a number of the PIE symbols comprised in the PIE-IM symbol is 2^{K}, where K is a number of data bits represented by the PIE-IM symbol.

Preferably, a number of the PIE symbols comprised in the PIE-IM symbol is 2^{K}+A, where K is a number of data bits represented by the PIE-IM symbol and A is a number of the PIE-IM symbols configured to indicate non-data information.

Preferably, K is 1, 2 or 3

Preferably, a number of the PIE symbols corresponding to each pulse width is not greater than a first integer and is not smaller than a second integer.

Preferably, the first integer is a smallest integer greater than or equal to a quotient of dividing a number of PIE symbols in the PIE-IM symbol by a number of the different pulse widths.

Preferably, the second integer is a greatest integer smaller than or equal to the quotient of dividing the number of PIE symbols in the PIE-IM symbol by the number of the different pulse widths.

Preferably, the number of the PIE symbols corresponding to each pulse width is equal to a quotient of dividing the number of PIE symbols in the PIE-IM symbol by the number of the different pulse widths.

Preferably, the number of the PIE symbols corresponding to each pulse width is 1

Preferably, wherein a number M of PIE symbols in one PIE-IM symbol, a number L of the different pulse widths, a number Mₗ of PIE symbols which has a pulse width PWₗ and is comprised in one PIE-IM symbol, where l=0 to L−1, and a number of data bits indicated by one PIE-IM symbol are determined according to those corresponding to at least one of indexes in the following table:

| Index | M | L | Mₗ, l = 0~L-1 | K |
|---|---|---|---|---|
| 1 | 3 | 2 | M₀ = 2, M₁ = 1 | 1 |
| 2 | 3 | 3 | M₀ = 1, M₁ = 1, M₂ = 1 | 2 |
| 3 | 4 | 3 | M₀ = 2, M₁ = 1, M₂ = 1 | 3 |
| 4 | 5 | 3 | M₀ = 3, M₁ = 1, M₂ = 1 | 4 |
| 5 | 5 | 4 | M₀ = 2, M₁ = 1, M₂ = 1, M₃ = 1 | 5 |
| 6 | 6 | 3 | M₀ = 2, M₁ = 2, M₂ = 2 | 6 |
| 7 | 6 | 4 | M₀ = 2, M₁ = 2, M₂ = 1, M₃ = 1 | 7 |
| 8 | 7 | 2 | M₀ = 4, M₁ = 3 | 5 |
| 9 | 7 | 3 | M₀ = 3, M₁ = 3, M₂ = 1 | 7 |
| 10 | 7 | 4 | M₀ = 2, M₁ = 2, M₂ = 2, M₃ = 1 | 9 |
| 11 | 8 | 3 | M₀ = 3, M₁ = 3, M₂ = 2 | 9 |
| 12 | 8 | 4 | M₀ = 3, M₁ = 3, M₂ = 1, M₃ = 1 | 10 |

Preferably, transmitting, to the second node, the at least one symbol corresponding to the at least one data bit comprises: transmitting, to a second node, the at least one symbol corresponding to the at least one data bit by using a plurality of orthogonal frequency division multiplexing sub-carriers.

The present disclosure relates to a wireless communication method for use in a second node, the method comprising:
receiving, from a first node, at least one symbol corresponding to the at least one data bit, wherein each symbol is one of a plurality of pulse-interval encoding (PIE) index modulation (IM) symbols, and
demodulating the at least one symbol, to generate the at least one data bit.

Various embodiments may preferably implement the following features:

Preferably, each PIE-IM symbol comprises a same plurality of PIE symbols.

Preferably, the PIE symbols have a plurality of different pulse widths.

Preferably, at least one of the plurality of PIM-IM symbols is configured to indicate non-data information.

Preferably, the non-data information comprises at least one of: a start of reading, an end of reading, a start of writing, or an end of writing.

Preferably, at least one of the plurality of PIM-IM symbols is configured to indicate non-data information is forbidden to be used.

Preferably, the plurality of PIE symbols consists of at least one first PIE symbol with a first pulse width and at least one second PIE symbol with a second pulse width greater than the first pulse width.

Preferably, each PIE-IM symbol comprises only one second PIE symbol.

Preferably, information indicated by the PIE-IM symbol is determined based on a position of the second PIE symbol in the PIM-IM symbol.

Preferably, a number of the PIE symbols comprised in the PIE-IM symbol is 2^{K}, where K is a number of data bits represented by the PIE-IM symbol.

Preferably, a number of the PIE symbols comprised in the PIE-IM symbol is 2^{K}+A, where K is a number of data bits represented by the PIE-IM symbol and A is a number of the PIE-IM symbols configured to indicate non-data information.

Preferably, K is 1, 2 or 3

Preferably, a number of the PIE symbols corresponding to each pulse width is not greater than a first integer and is not smaller than a second integer.

Preferably, the first integer is a smallest integer greater than or equal to a quotient of dividing a number of PIE symbols in the PIE-IM symbol by a number of the different pulse widths.

Preferably, the second integer is a greatest integer smaller than or equal to the quotient of dividing the number of PIE symbols in the PIE-IM symbol by the number of the different pulse widths.

Preferably, the number of the PIE symbols corresponding to each pulse width is equal to a quotient of dividing the number of PIE symbols in the PIE-IM symbol by the number of the different pulse widths.

Preferably, the number of the PIE symbols corresponding to each pulse width is 1

Preferably, wherein a number M of PIE symbols in one PIE-IM symbol, a number L of the different pulse widths, a number Mₗ of PIE symbols which has a pulse width PWₗ and is comprised in one PIE-IM symbol, where l=0 to L−1, and a number of data bits indicated by one PIE-IM symbol are determined according to those corresponding to at least one of indexes in the following table:

| Index | M | L | Mₗ, l = 0~L-1 | K |
|---|---|---|---|---|
| 1 | 3 | 2 | M₀ = 2, M₁ = 1 | 1 |
| 2 | 3 | 3 | M₀ = 1, M₁ = 1, M₂ = 1 | 2 |
| 3 | 4 | 3 | M₀ = 2, M₁ = 1, M₂ = 1 | 3 |
| 4 | 5 | 3 | M₀ = 3, M₁ = 1, M₂ = 1 | 4 |
| 5 | 5 | 4 | M₀ = 2, M₁ = 1, M₂ = 1, M₃ = 1 | 5 |
| 6 | 6 | 3 | M₀ = 2, M₁ = 2, M₂ = 2 | 6 |
| 7 | 6 | 4 | M₀ = 2, M₁ = 2, M₂ = 1, M₃ = 1 | 7 |
| 8 | 7 | 2 | M₀ = 4, M₁ = 3 | 5 |
| 9 | 7 | 3 | M₀ = 3, M₁ = 3, M₂ = 1 | 7 |
| 10 | 7 | 4 | M₀ = 2, M₁ = 2, M₂ = 2, M₃ = 1 | 9 |
| 11 | 8 | 3 | M₀ = 3, M₁ = 3, M₂ = 2 | 9 |
| 12 | 8 | 4 | M₀ = 3, M₁ = 3, M₂ = 1, M₃ = 1 | 10 |

Preferably, receiving, from the first node, the at least one symbol corresponding to the at least one data bit comprises: receiving, from the first node, the at least one symbol corresponding to the at least one data bit in a plurality of orthogonal frequency division multiplexing sub-carriers.

Preferably, demodulating the at least one symbol, to generate the at least one data bit comprises: determining a transmission error if the at least one symbol comprises the PIE-IM symbol configured to indicate forbidden to be used.

Preferably, the wireless communication method further comprises terminating the reception of the at least one symbol, and/or transmitting, to the first node, a retransmission request.

The present disclosure relates to a first node. The first node comprises:
a processor, configured to modulate at least one data bit to generate at least one symbol, wherein each symbol is one of a plurality of pulse-interval encoding (PIE) index modulation (IM) symbols, and
a communication unit, configured to transmit, to a second node, the at least one symbol corresponding to the at least one data bit.

Various embodiments may preferably implement the following feature:

Preferably, the processor is further configured to perform any of the aforementioned wireless communication methods.

The present disclosure relates to a second node. The second node comprises:
a communication unit, configured to receive, from a first node, at least one symbol corresponding to the at least one data bit, wherein each symbol is one of a plurality of pulse-interval encoding (PIE) index modulation (IM) symbols, and
a processor, configured to demodulate the at least one symbol, to generate the at least one data bit.

Various embodiments may preferably implement the following feature:

Preferably, the processor is further configured to perform any of the aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The invention is specified by the independent claims. Preferred embodiments are defined in the dependent claims. In the following description, although numerous features may be designated as optional, it is nevertheless acknowledged that all features comprised in the independent claims are not to be read as optional.

The above and other aspects and their implementations are described in greater detail in the drawings, the descriptions, and the claims.

### BRIEF DESCRIPTION OF THE DRAWINGS

FIGS. 1A and 1B show a schematic diagram of PIE waveforms according to an embodiment of the present disclosure.

FIG. 2 shows a schematic diagram of a mapping between PIE-IM symbols and data bits according to an embodiment of the present disclosure.

FIG. 3 shows a schematic diagram of a mapping between PIE-IM symbols and data bits according to an embodiment of the present disclosure.

FIG. 4 shows a schematic diagram of a mapping between PIE-IM symbols and data bits according to an embodiment of the present disclosure.

FIG. 5 shows a schematic diagram of a mapping between PIE-IM symbols and representation according to an embodiment of the present disclosure.

FIG. 6 shows a schematic diagram of a mapping between PIE-IM symbols and representation according to an embodiment of the present disclosure.

FIG. 7 shows a schematic diagram of a mapping between PIE-IM symbols and representation according to an embodiment of the present disclosure.

FIG. 8 shows a schematic diagram of a mapping between PIE-IM symbols and representation according to an embodiment of the present disclosure.

FIG. 9 shows a schematic diagram of a network (architecture) according to an embodiment of the present disclosure.

FIG. 10 shows an example of a schematic diagram of a wireless terminal according to an embodiment of the present disclosure.

FIG. 11 shows an example of a schematic diagram of a wireless network node according to an embodiment of the present disclosure.

FIG. 12 shows a flowchart of a method according to an embodiment of the present disclosure.

FIG. 13 shows a flowchart of a method according to an embodiment of the present disclosure.

### DETAILED DESCRIPTION OF THE EMBODIMENTS

To support the massive number of low-cost IoT devices, a (6G) communication system is expected to support passive communications. The passive IoT devices are extremely low-power and low-cost, which can be a very simple tag. To support the simple downlink signal receptions, a PIE (Pulse Interval Encoding) may be an option. Particularly, the PIE is a scheme that uses pulse intervals/widths to modulate data, which is friendly to the low-complexity IoT devices because a demodulation of the PIE only requires the IoT device to count the pulse widths and to compare/determine the counting result. However, there are two limitations of PIE including unequal widths/lengths of PIE symbols, which lead to unknown packet length, and bad frequency offset resistance which leads to errors in obtaining pulse widths.

The present disclosure provides methods and devices for not only passive IoT devices but also ambient IoT devices and/or any UE (user equipment) having a lower-power receiver (e.g., the UE having a low-power wake-up signal). For example, there are three types of ambient IoT devices:
Type A: The IoT device is purely passive and uses backscatter communications,
Type B: The IoT device has a capacitor to store energy and uses the backscatter communications, and
Type C: The IoT device has a capacitor to store energy and is able to actively generate signal.

In the present disclosure, different PIE symbols/waveforms are distinguished from each other by their pulse widths.

In the present disclosure, the pulse width can be replaced by the pulse intervals without affecting the technical effect, as the pulse interval is a sum of a pulse width and a logical low width.

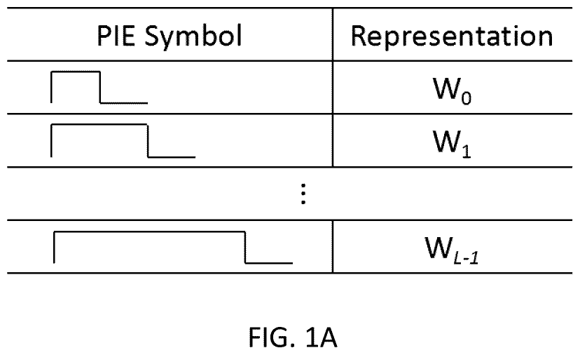

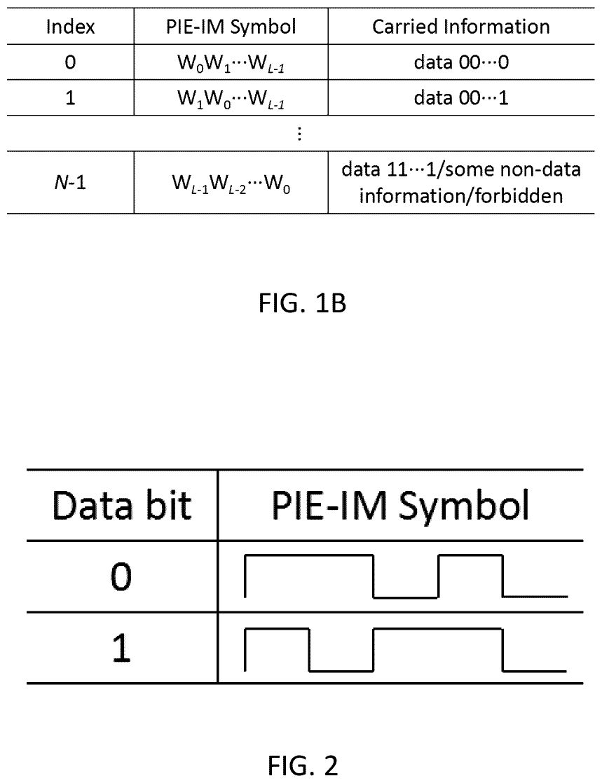

FIGS. 1A and 1B show schematic diagrams of PIE waveforms according to an embodiment of the present disclosure. This embodiment shows general forms of PIE-IM (PIE index modulation) symbols. In this embodiment, one PIE-IM symbol uses M PIE symbols/waveforms which have L different pulse widths as shown in FIG. 1A. Specifically, a simplified representation PIE symbol/waveform of Wₗ is used to represent the width-l PIE symbol, where l=0, 1, . . . , L−1. The M PIE symbols having the L widths are used to represent K bits (i.e., carried information shown in FIG. 1B). The number of the PIE symbols Wₗ having the width-l within one PIE-IM symbol is My. The total non-repetitive permutations number N of the M PIE symbols (i.e., the number of permutations of the M PIE symbols without repeated permutations) can be expressed as:

$$N = M ! / {\prod }_{l = 0}^{L - 1} {M}_{l}$$

In this case, the data bit number K satisfies K≤log 2(N). As N may not be a power of 2, there are some non-repetitive permutations are not used by the K-bit data representation. In an embodiment, at least part of the unused non-repetitive permutations can be used to represent/indicate certain non-data information, e.g., the end of writing, and the beginning of reading. As an alternative or in addition, at least part of the unused non-repetitive permutations may be forbidden to be used. If detecting a forbidden PIE symbol, the receiver determines that an error is detected. If the error is detected, the receiver may implement some pertinent operations, e.g., receiving termination, and/or (transmitting) re-transmission request.

The PIE-IM symbols can be represented by a time-domain signal, which is directly transmitted in the time domain. The PIE-IM symbols can also be represented by the frequency-domain data in multiple sub-carriers of OFDM, which is transformed into the time-domain via an IFFT (inverse fast Fourier transform) and then transmitted.

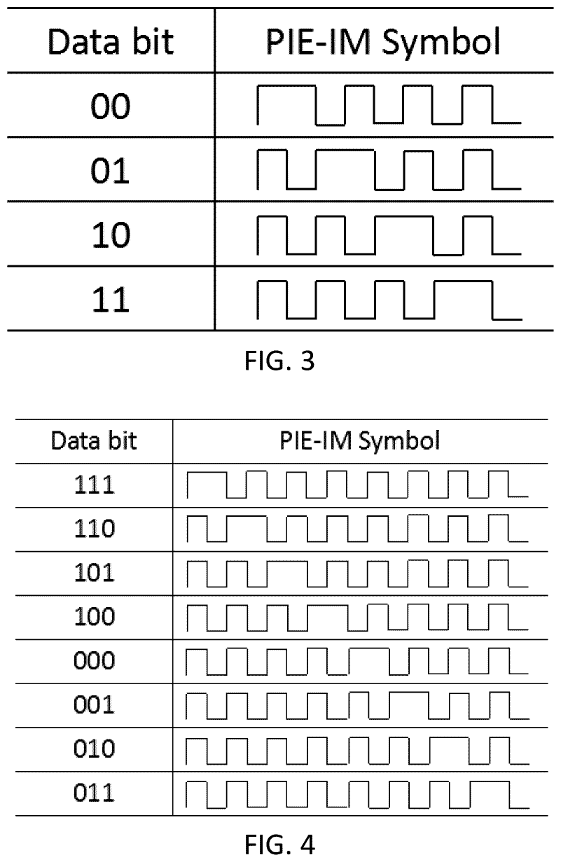

In an embodiment, a form of PIE-IM symbols may set M=L=2, M₀=M₁=1, N=2. One mapping example for this embodiment is shown in FIG. 3. Note that the mapping between data bits and PIE-IM symbols shown in FIG. 2 may be arbitrary altered.

At the transmitter, the data bits are mapped into PIE-IM symbols. The PIE-IM symbols decides the amplitude of the transmitted signal.

At the receiver, the PIE-symbols are demodulated into data bits by using the same mapping rules.

In an embodiment, a form of PIE-IM symbol sets M=2^{K}, L=2, M₀=M−1, M₁=1, N=M. One mapping example of K=2 is shown in FIG. 3. In this embodiment, the position of the wider pulse interval is used to represent the binary numbers from 00 to 11. Note that the mapping between data bits and PIE-IM symbols shown in FIG. 3 may be arbitrary altered.

At the transmitter, the data bits are mapped into PIE-IM symbols. The PIE-IM symbols decides the amplitude of the transmitted signal. This embodiment has an advantage of a relatively high spectrum efficiency.

At the receiver, the PIE-symbols are demodulated into data bits using the same mapping rules. This embodiment is very simple, the low-complexity receiver is required to detect (only) the position of the widest pulse for determining the data bits corresponding to or indicated by the detected PIE-IM symbol. This embodiment also has an advantage of a relatively high spectrum efficiency.

In an embodiment, a form of PIE-IM symbol sets M=2^{K}, L=2, M₀=M−1, M₁=1, N=M. One mapping example of K=3 for this embodiment is shown in FIG. 4. Note that the mapping between data bits and PIE-IM symbols shown in FIG. 4 may be arbitrary altered.

At the transmitter, the data bits are mapped into PIE-IM symbols. The PIE-IM symbols decides the amplitude of the transmitted signal.

At the receiver, the PIE-symbols are demodulated into data bits using the same mapping rules. In this embodiment, the (low-complexity) receiver is required to detect only the position of the widest pulse for determining the data bits corresponding to or indicated by the detected PIE-IM symbol.

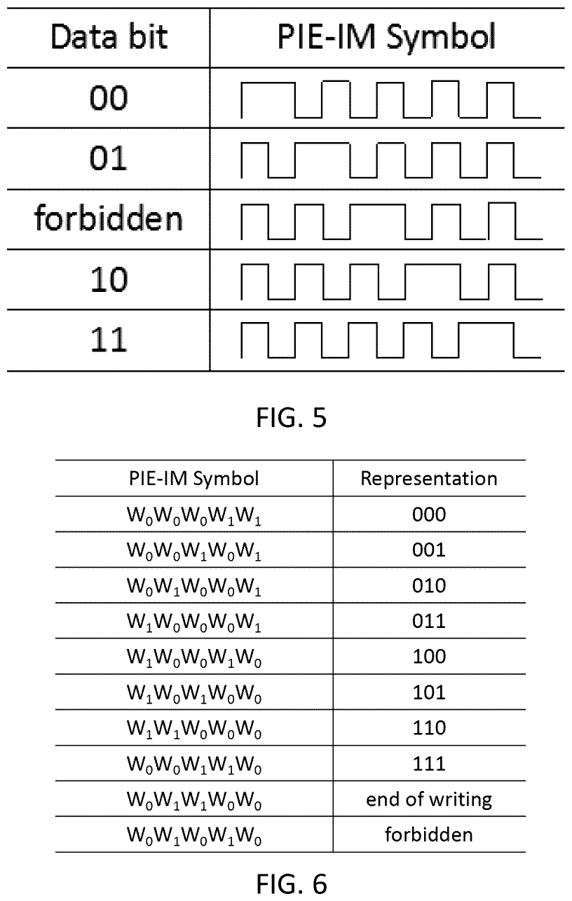

In an embodiment, a form of PIE-IM symbol sets M=2^{K}+A, L=2, M₀=M−1, M₁=1, N=M. One mapping example of K=2 and A=1 for this embodiment is shown in FIG. 5. As shown in FIG. 5, four different PIE-IM symbols are used to represent 2-bit data, and one PIE-IM symbol is forbidden to use. Note that the mapping between data bits and PIE-IM symbols shown in FIG. 5 may be arbitrary altered.

At the transmitter, the data bits are mapped into PIE-IM symbols. The PIE-IM symbols decides the amplitude of the transmitted signal.

At the receiver, the PIE-symbols are demodulated into data bits using the same mapping rules. If the receiver detects a forbidden PIE symbol, the receiver determines that an error is detected. When the error is detected, the receiver can implement some pertinent operations, e.g., receiving termination, or (transmitting) re-transmission request. Note that the mapping between data bits and PIE-IM symbols shown in FIG. 5 may be arbitrary altered. In this embodiment, the low-complexity receiver is required to detect only the position of the widest pulse for determining the data bits or non-data information corresponding to the detected PIE-IM symbol.

In an embodiment of a form of PIE-IM symbols, M₀~M_{L-1} are set as:

┌M/L┐≥M₀≥M₁≥ . . . ≥M_{L-1}≥└M/L┘
where ┌X┐ refers to a ceil function of outputting the smallest integer greater than or equal to the input variable X and └X┘ refers to a floor function of outputting the greatest integer smaller than or equal to the input variable X.

In this embodiment, the setting gives the largest non-repetitive permutation number with the shortest length. Therefore, the spectrum efficiency is high. One mapping example for this embodiment is shown in FIG. 6, wherein M=5, L=2, M₀=3, M₁=2, N=10, and K=3. Note that the mapping between the PIE-IM symbol and representations shown in FIG. 6 may be arbitrarily adjusted.

At the transmitter, the data bits and non-data information are mapped into the PIE-IM symbols based on the mapping (rules) shown in FIG. 6. The PIE-IM symbols decides the amplitude of the transmitted signal.

At the receiver, the PIE-symbols are demodulated into data bits by using the same mapping (rules) shown in FIG. 6. Because the PIE-IM symbol W₀W₁W₀W₁W₀ is forbidden, an error is detected if it is detected by the receiver. If detecting the error (i.e., detecting the PIE-IM symbol PIE-IM symbol W₀W₁W₀W₁W₀), the receiver may terminate the reception and/or transmit the re-transmission request.

In an embodiment, a form of PIE-IM symbols sets M₀~M_{L-1} as:

┌M/L┘≥M₀≥M₁≥ . . . ≥M_{L-1}≥└M/L┘
where ┌X┘ refers to a ceil function of outputting the smallest integer greater than or equal to the input variable X and └X┘ refers to a floor function of outputting the greatest integer smaller than or equal to the input variable X.

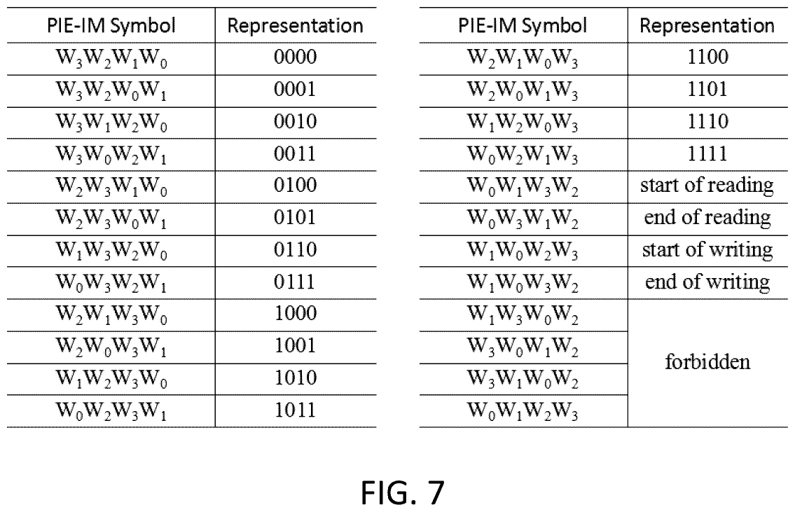

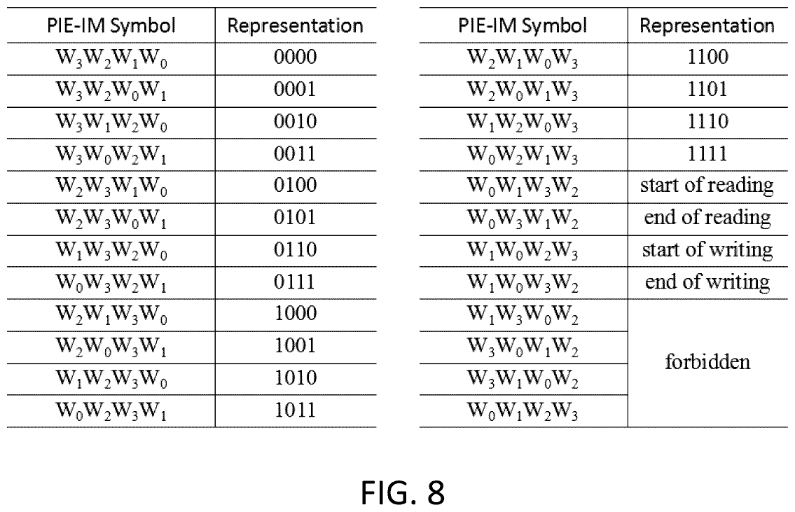

This setting gives the largest non-repetitive permutation number with the shortest length and the spectrum efficiency is high. One mapping example for this embodiment is shown in FIG. 7, wherein M=6, L=2, M₀=M₁=3, N=20, and K=4. The mapping between the PIE-IM symbols and the representations shown in FIG. 8 may be arbitrarily adjusted.

At the transmitter, the data bits and non-data information are mapped into the PIE-IM symbols based on the mapping rules shown in FIG. 7. The PIE-IM symbols decides the amplitude of the transmitted signal.

At the receiver, the PIE-symbols are demodulated into data bits and the non-data information by using the same mapping rules shown in FIG. 7.

In an embodiment, a form of PIE-IM symbols sets M=L and M₀=M₁= . . . =M_{L-1}. In this embodiment, the setting gives the largest non-repetitive permutation number with the shortest length. Thus, the spectrum efficiency is high. One mapping example for this embodiment is shown in FIG. 8, wherein M=L=4, M₀=M₁=M₂=M₃=1, N=24, and K=4. In the mapping shown in FIG. 8, the position of the widest pulse W3 among all pulses is used to decide the first two bits, the position of the second widest pulse W2 is used to decide the third bit, and the position of the third widest pulse W1 is used to decide the fourth bit. When the position of the second widest pulse W2 is 3, the PIE-IM symbols are used/configured to represent/indicate certain non-data information or forbidden to use.

The mapping between the PIE-IM symbols and the representations may be changed.

At the transmitter, the data bits and non-data information are mapped into PIE-IM symbols based on the mapping (rules) shown in FIG. 8. The PIE-IM symbols decides the amplitude of the transmitted signal.

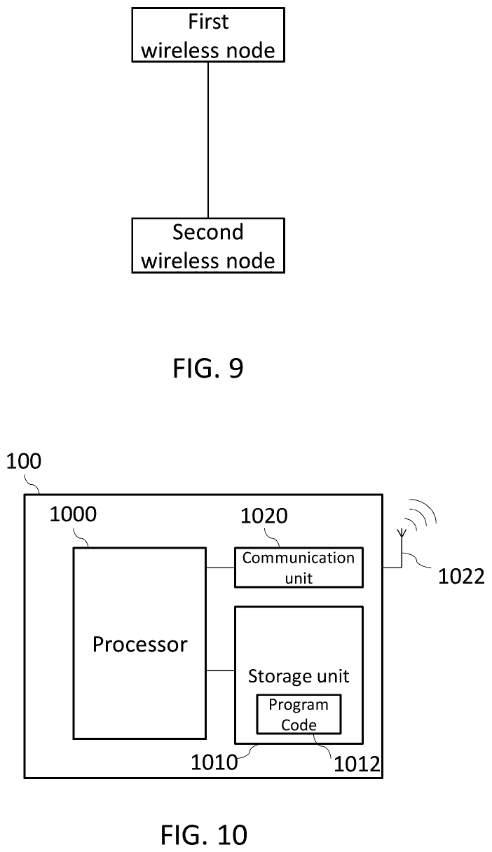

At the receiver, the PIE-symbols are demodulated into data bits and the non-data information by using the same mapping (rules) shown in FIG. 9. Since some PIE-IM symbols are forbidden, an error is detected if any of them is found. Then, the receiver may terminate the reception and/or transmit the re-transmission request.

Table 1 lists various forms of the PIE-IM symbols, where M=2 to 8 and L=2 to 4.

TABLE 1

| Index | M | L | Mₗ, 1 = 0~L-1 | K |
|---|---|---|---|---|
| 1 | 3 | 2 | M₀ = 2, M₁ = 1 | 1 |
| 2 | 3 | 3 | M₀ = 1, M₁ = 1, M₂ = 1 | 2 |
| 3 | 4 | 3 | M₀ = 2, M₁ = 1, M₂ = 1 | 3 |
| 4 | 5 | 3 | M₀ = 3, M₁ = 1, M₂ = 1 | 4 |
| 5 | 5 | 4 | M₀ = 2, M₁ = 1, M₂ = 1, M₃ = 1 | 5 |
| 6 | 6 | 3 | M₀ = 2, M₁ = 2, M₂ = 2 | 6 |
| 7 | 6 | 4 | M₀ = 2, M₁ = 2, M₂ = 1, M₃ = 1 | 7 |
| 8 | 7 | 2 | M₀ = 4, M₁ = 3 | 5 |
| 9 | 7 | 3 | M₀ = 3, M₁ = 3, M₂ = 1 | 7 |
| 10 | 7 | 4 | M₀ = 2, M₁ = 2, M₂ = 2, M₃ = 1 | 9 |
| 11 | 8 | 3 | M₀ = 3, M₁ = 3, M₂ = 2 | 9 |
| 12 | 8 | 4 | M₀ = 3, M₁ = 3, M₂ = 1, M₃ = 1 | 10 |

In an embodiment, at least part of the forms shown in Table 1 are be adopted for the consensus of transmission and reception. If multiple forms shown in Table 1 are adopted, the adopted forms should be decided before the transmission via certain configurations.

FIG. 9 shows a schematic diagram of a network (architecture) according to an embodiment of the present disclosure. The network (architecture) shown in FIG. 9 comprises a first wireless node and a second wireless node communicating with each other. In an embodiment, the first wireless node is a BS (e.g., a gNB, a RAN node), a UE or a transmitter. In an embodiment, the second wireless node is a UE, an IoT device or a receiver.

In an embodiment, a first wireless node uses a plurality of PIE-IM symbols to modulate at least one data bit, wherein each PIE-IM symbol comprises a plurality of PIE symbols, and the PIE symbols have a plurality of different pulse widths. The first wireless node transmits the PIE-IM symbols to the second wireless node.

In an embodiment, the PIE symbols have at least two different pulse widths.

In an embodiment, at least a part of PIE symbols has the same pulse width. That is, within one PIE-IM symbol, there may be some PIE symbols having the same pulse widths (see, e.g., FIGS. 3 to 7.

In an embodiment, only one PIE symbol in the PIM-IM symbol has a pulse width wider than pulse widths of the remaining PIE symbols (see, e.g., FIGS. 3 to 5).

In an embodiment, the position of the PIE symbol having the wider pulse widths is used to modulate/indicate the corresponding data bits.

In an embodiment, the PIE-IM symbol comprises 2^{K} PIE symbols.

In an embodiment, the PIE-IM symbol comprises 2^{K} PIE symbols and each PIE-IM symbol is used/configured to convey K data bits, where K is an integer ≥1.

In an embodiment, K=1 or 2 or 3.

In an embodiment, the number of PIE symbols in each PIE-IM symbol is 2^{K}+A. In this embodiment, 2^{K}+A different PIE-IM symbols can be generated. Among the 2^{K}+A PIE-IM symbols, 2^{K} PIE-IM symbols are used to modulate/indicate K data bits and A PIE-IM symbols are used to convey non-data information or forbidden to use.

In an embodiment, the number of PIE symbols corresponding to each pulse width is the largest integer no more than the division of the number of PIE symbols and the number of different pulse widths, or the smallest integer no less than the division of the number of PIE symbols and the number of different pulse widths (see, e.g., FIGS. 6 and 7).

In an embodiment, the number of PIE symbols corresponding to each pulse width is the division of the number of PIE symbols and the number of different pulse widths.

In an embodiment, the form of the PIE-IM symbols is set according to the parameters corresponding to at least one index of Table 1.

In an embodiment, at least one of the PIE-IM symbols is used to convey non-data information.

In an embodiment, the non-data information includes at least one of start of reading, end of reading, start of writing and end of writing.

In an embodiment, at least one of the PIE-IM symbols is forbidden to use.

In an embodiment, if the second wireless node detects a forbidden PIE symbol (i.e., the PIE-IM symbols forbidden to use), the second wireless node determines that error is detected.

In an embodiment of the error is detected, the second wireless node takes/performs operations including at least one of a receiving termination and transmitting a re-transmission request.

In an embodiment, the PIE-IM symbols are transmitted by using multiple sub-carriers in an OFDM (orthogonal frequency division multiplexing) system.

FIG. 10 relates to a schematic diagram of a wireless terminal 100 according to an embodiment of the present disclosure. The wireless terminal 100 may be a user equipment (UE), a mobile phone, a laptop, a tablet computer, an electronic book or a portable computer system and is not limited herein. The wireless terminal 100 may include a processor 1000 such as a microprocessor or Application Specific Integrated Circuit (ASIC), a storage unit 1010 and a communication unit 1020. The storage unit 1010 may be any data storage device that stores a program code 1012, which is accessed and executed by the processor 1000. Embodiments of the storage unit 1010 include but are not limited to a subscriber identity module (SIM), read-only memory (ROM), flash memory, random-access memory (RAM), hard-disk, and optical data storage device. The communication unit 1020 may a transceiver and is used to transmit and receive signals (e.g., messages or packets) according to processing results of the processor 1000. In an embodiment, the communication unit 1020 transmits and receives the signals via at least one antenna 1022 shown in FIG. 10.

In an embodiment, the storage unit 1010 and the program code 1012 may be omitted and the processor 1000 may include a storage unit with stored program code.

The processor 1000 may implement any one of the steps in exemplified embodiments on the wireless terminal 100, e.g., by executing the program code 1012.

The communication unit 1020 may be a transceiver. The communication unit 1020 may as an alternative or in addition be combining a transmitting unit and a receiving unit configured to transmit and to receive, respectively, signals to and from a wireless network node (e.g., a base station).

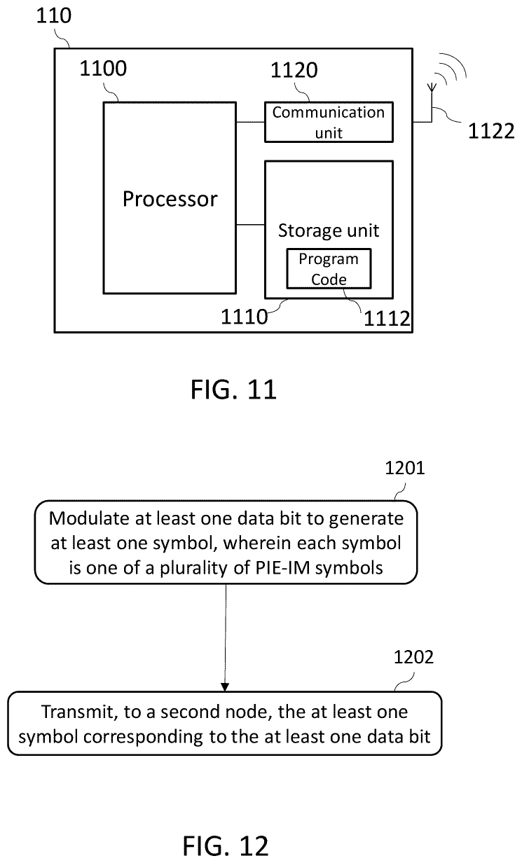

FIG. 11 relates to a schematic diagram of a wireless network node 110 according to an embodiment of the present disclosure. The wireless network node 110 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 110 may comprise (perform) at least one network function such as an access and mobility management function (AMF), a session management function (SMF), a user place function (UPF), a policy control function (PCF), an application function (AF), etc. The wireless network node 110 may include a processor 1100 such as a microprocessor or ASIC, a storage unit 1110 and a communication unit 1120. The storage unit 1110 may be any data storage device that stores a program code 1112, which is accessed and executed by the processor 1100. Examples of the storage unit 1110 include but are not limited to a SIM, ROM, flash memory, RAM, hard-disk, and optical data storage device. The communication unit 1120 may be a transceiver and is used to transmit and receive signals (e.g., messages or packets) according to processing results of the processor 1100. In an example, the communication unit 1120 transmits and receives the signals via at least one antenna 1122 shown in FIG. 11.

In an embodiment, the storage unit 1110 and the program code 1112 may be omitted. The processor 1100 may include a storage unit with stored program code.

The processor 1100 may implement any steps described in exemplified embodiments on the wireless network node 110, e.g., via executing the program code 1112.

The communication unit 1120 may be a transceiver. The communication unit 1120 may as an alternative or in addition be combining a transmitting unit and a receiving unit configured to transmit and to receive, respectively, signals to and from a wireless terminal (e.g., a user equipment or another wireless network node).

FIG. 12 shows a flowchart of a method according to an embodiment of the present disclosure. The method shown in FIG. 12 may be used in a first node (e.g., the first wireless node shown in FIG. 9) and comprises the following steps:

Step 1201: Modulate at least one data bit to generate at least one symbol, wherein each symbol is one of a plurality of PIE-IM symbols.

Step 1202: Transmit, to a second node, the at least one symbol corresponding to the at least one data bit.

In FIG. 12, the first node transmits at least one symbol corresponding to the at least one data bit to a second node (e.g., the second wireless node shown in FIG. 9). In this embodiment, the transmitted symbol(s) is acquired/generated by modulating the data bit(s) by using a plurality of PIE-IM symbols. That is each transmitted symbol is one of the PIE-IM symbols.

In an embodiment, each PIE-IM symbol comprises a same plurality of PIE symbols. That is the PIE-IM symbols may refer to different permutations of the same PIE symbols. As an alternative or in addition, each PIE-IM symbol is consisted of the same PIE symbols.

In an embodiment, the PIE symbols have different widths/intervals (see, e.g., FIGS. 1A and 1B). For example, the PIE symbols forming the PIE-IM symbols have at least two pulse widths/intervals.

In an embodiment, all the PIE symbols forming the PIE-IM symbol have different widths/intervals (see, e.g., FIG. 2, 7 or 8). In other words, in this embodiment, the PIE symbols forming the PIE-IM symbols are different from each other.

In an embodiment, at least part of PIE symbols forming the PIE-IM symbol have different widths/intervals and/or at least part of PIE symbols forming the PIE-IM symbol have the same width/interval. In this embodiment, there may be the PIE symbols having the same widths/intervals in each PIE-IM symbol (see, e.g., FIG. 3, 4, 5 or 6). As an alternative or in addition, there is at least one PIE symbol having a width/interval different from that of the remaining PIE symbols in the PIE-IM symbol.

In an embodiment, the PIM-IM symbol may represent at least one data bit.

In an embodiment, at least one of the PIM-IM symbols is configured to indicate non-data information. For example, the non-data information comprises at least one of: a start of reading, an end of reading, a start of writing, or an end of writing.

In an embodiment, at least one of the PIM-IM symbols is configured to indicate “forbidden to be used”.

In an embodiment, the plurality of PIE symbols consists of at least one first PIE symbol with a first pulse width and at least one second PIE symbol with a second pulse width greater than the first pulse width (see, e.g., FIG. 2, 3, 4, 5 or 6). In this embodiment, each PIE-IM symbol may comprise only one second PIE symbol (see, e.g., FIG. 2, 3, 4, or 5). In an embodiment of the PIE-IM symbol comprising only one second PIE symbol, information indicated by the PIE-IM symbol is determined based on a position of the second PIE symbol in the PIM-IM symbol (see, e.g., FIG. 2, 3, 4, or 5). Particularly, the number of the PIE symbols comprised in the PIE-IM symbol may be 2^{K}, where K is a number of data bits represented by the PIE-IM symbol. As an alternative, the number of the PIE symbols comprised in the PIE-IM symbol is 2^{K}+A, where K is a number of data bits represented by the PIE-IM symbol and A is the number of the PIE-IM symbols configured to indicate non-data information. In an embodiment, K is set as 1, 2 or 3.

In an embodiment, the number of the PIE symbols corresponding to each pulse width is not greater than a first integer and is not smaller than a second integer. The first integer is a smallest integer greater than or equal to a quotient of dividing a number of PIE symbols in the PIE-IM symbol by a number of the different pulse widths. The second integer is a greatest integer smaller than or equal to the quotient of dividing the number of PIE symbols in the PIE-IM symbol by the number of the different pulse widths.

In an embodiment, the number of the PIE symbols corresponding to each pulse width is equal to a quotient of dividing the number of PIE symbols in the PIE-IM symbol by the number of the different pulse widths.

In an embodiment, the number of the PIE symbols corresponding to each pulse width is 1 (see, e.g., FIG. 2, 7 or 8).

In an embodiment, the number M of PIE symbols in one PIE-IM symbol, the number L of the different pulse widths, the number Mₗ of PIE symbols which has a pulse width PWₗ and is comprised in one PIE-IM symbol (where I=0 to L−1) and the number K of data bits indicated by one PIE-IM symbol are determined according to those corresponding to at least one of indexes in above Table 1.

In an embodiment, the first node transmits the at least one symbol corresponding to the at least one data bit to the second node by using a plurality of OFDM sub-carriers.

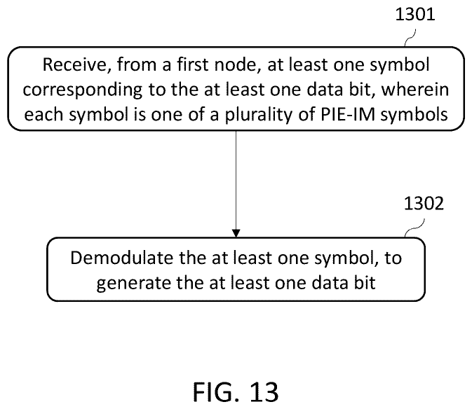

FIG. 13 shows a flowchart of a method according to an embodiment of the present disclosure. The method shown in FIG. 13 may be used in a second node (e.g., the second wireless node shown in FIG. 9) and comprises the following steps:

Step 1301: Receive, from a first node, at least one symbol corresponding to the at least one data bit, wherein each symbol is one of a plurality of PIE-IM symbols.

Step 1302: Demodulate the at least one symbol, to generate the at least one data bit.

In FIG. 13, the second node receives at least one symbol corresponding to the at least one data bit from a first node (e.g., the first wireless node in FIG. 9), where each symbol is one of a plurality of PIE-IM symbols. To generate the data bit(s), the second node demodulates the received symbol(s), e.g., based on a mapping between the PIE-IM symbols and corresponding information (e.g., data bit(s) and/or non-data information).

In an embodiment, each PIE-IM symbol comprises a same plurality of PIE symbols. That is the PIE-IM symbols may refer to different permutations of the same PIE symbols. As an alternative of in addition, each PIE-IM symbol is consisted of the same PIE symbols.

In an embodiment, the PIE symbols have different widths/intervals (see, e.g., FIGS. 1A and 1B). For example, the PIE symbols forming the PIE-IM symbols have at least two pulse widths/intervals.

In an embodiment, all the PIE symbols forming the PIE-IM symbols have different widths/intervals (see, e.g., FIG. 2, 7 or 8). In other words, in this embodiment, the PIE symbols forming the PIE-IM symbols are different from each other.

In an embodiment, at least part of PIE symbols forming the PIE-IM symbol have different widths/intervals and/or at least part of PIE symbols forming the PIE-IM symbol have the same width/interval. In this embodiment, there may be the PIE symbols having the same widths/intervals in each PIE-IM symbol (see, e.g., FIG. 3, 4, 5 or 6). As an alternative or in addition, there is at least one PIE symbol having a width/interval different from that of the remaining PIE symbols in the PIE-IM symbol.

In an embodiment, the PIM-IM symbol may represent at least one data bit.

In an embodiment, at least one of the PIM-IM symbols is configured to indicate non-data information. For example, the non-data information comprises at least one of: a start of reading, an end of reading, a start of writing, or an end of writing.

In an embodiment, at least one of the PIM-IM symbols is configured to indicate “forbidden to be used”.

In an embodiment, the plurality of PIE symbols consists of at least one first PIE symbol with a first pulse width and at least one second PIE symbol with a second pulse width greater than the first pulse width (see, e.g., FIG. 2, 3, 4, 5 or 6). In this embodiment, each PIE-IM symbol may comprise only one second PIE symbol (see, e.g., FIG. 2, 3, 4, or 5). In an embodiment of the PIE-IM symbol comprising only one second PIE symbol, information indicated by the PIE-IM symbol is determined based on a position of the second PIE symbol in the PIM-IM symbol (see, e.g., FIG. 2, 3, 4, or 5). Particularly, the number of the PIE symbols comprised in the PIE-IM symbol may be 2^{K}, where K is a number of data bits represented by the PIE-IM symbol. As an alternative, the number of the PIE symbols comprised in the PIE-IM symbol is 2^{K}+A, where K is a number of data bits represented by the PIE-IM symbol and A is the number of the PIE-IM symbols configured to indicate non-data information. In an embodiment, K is set as 1, 2 or 3.

In an embodiment, the number of the PIE symbols corresponding to each pulse width is not greater than a first integer and is not smaller than a second integer. The first integer is a smallest integer greater than or equal to a quotient of dividing a number of PIE symbols in the PIE-IM symbol by a number of the different pulse widths. The second integer is a greatest integer smaller than or equal to the quotient of dividing the number of PIE symbols in the PIE-IM symbol by the number of the different pulse widths.

In an embodiment, the number of the PIE symbols corresponding to each pulse width is equal to a quotient of dividing the number of PIE symbols in the PIE-IM symbol by the number of the different pulse widths.

In an embodiment, the number of the PIE symbols corresponding to each pulse width is 1 (see, e.g., FIG. 2, 7 or 8).

In an embodiment, the number M of PIE symbols in one PIE-IM symbol, the number L of the different pulse widths, the number Mₗ of PIE symbols which has a pulse width PWₗ and is comprised in one PIE-IM symbol (where l=0 to L−1) and the number K of data bits indicated by one PIE-IM symbol are determined according to those corresponding to at least one of indexes in above Table 1.

In an embodiment, the second node receives the at least one symbol corresponding to the at least one data bit from the first node in a plurality of OFDM sub-carriers.

In an embodiment, the second node may determine/detect a transmission error if the received symbol(s) comprises at least one PIE-IM symbol configured to indicate forbidden to be used.

In an embodiment of detecting/determining the transmission error, the second node may terminate the reception of the data symbol(s) and/or transmit a retransmission request to the first node (e.g., start a retransmission procedure).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a first node, the method comprising:
modulating at least one data bit to generate at least one symbol, wherein each symbol is one of a plurality of pulse-interval encoding (PIE) index modulation (IM) symbols, and
transmitting, to a second node, the at least one symbol corresponding to the at least one data bit,
wherein each PIE-IM symbol comprises a same plurality of PIE symbols,
wherein the PIE symbols have a plurality of different pulse widths.

2. The wireless communication method of claim 1, wherein at least one of the plurality of PIM-IM symbols is configured to indicate non-data information.

3. The wireless communication method of claim 2, wherein the non-data information comprises at least one of:
a start of reading,
an end of reading,
a start of writing, or
an end of writing.

4. The wireless communication method of claim 1, wherein at least one of the plurality of PIM-IM symbols is configured to indicate non-data information is forbidden to be used.

5. The wireless communication method of claim 1, wherein the plurality of PIE symbols consists of at least one first PIE symbol with a first pulse width and at least one second PIE symbol with a second pulse width greater than the first pulse width.

6. The wireless communication method of claim 5, wherein each PIE-IM symbol comprises only one second PIE symbol.

7. The wireless communication method of claim 6, wherein information indicated by the PIE-IM symbol is determined based on a position of the second PIE symbol in the PIM-IM symbol.

8. The wireless communication method of claim 5, wherein a number of the PIE symbols comprised in the PIE-IM symbol is 2^{K}, where K is a number of data bits represented by the PIE-IM symbol.

9. The wireless communication method of claim 5, wherein a number of the PIE symbols comprised in the PIE-IM symbol is 2^{K}+A, where K is a number of data bits represented by the PIE-IM symbol and A is a number of the PIE-IM symbols configured to indicate non-data information.

10. The wireless communication method of claim 8, wherein K is 1, 2 or 3.

11. The wireless communication method of claim 1, wherein a number of the PIE symbols corresponding to each pulse width is not greater than a first integer and is not smaller than a second integer,
wherein the first integer is a smallest integer greater than or equal to a quotient of dividing a number of PIE symbols in the PIE-IM symbol by a number of the different pulse widths, and
wherein the second integer is a greatest integer smaller than or equal to the quotient of dividing the number of PIE symbols in the PIE-IM symbol by the number of the different pulse widths.

12. The wireless communication method of claim 11, wherein the number of the PIE symbols corresponding to each pulse width is equal to a quotient of dividing the number of PIE symbols in the PIE-IM symbol by the number of the different pulse widths.

13. The wireless communication method of claim 12, wherein the number of the PIE symbols corresponding to each pulse width is 1.

14. The wireless communication method of claim 1, wherein a number M of PIE symbols in one PIE-IM symbol, a number L of the different pulse widths, a number Mₗ of PIE symbols which has a pulse width PWₗ and is comprised in one PIE-IM symbol, where l=0 to L−1, and a number K of data bits indicated by one PIE-IM symbol are determined according to those corresponding to at least one of indexes in the following table:

| Index | M | L | Mₗ, l = 0~L-1 | K |
|---|---|---|---|---|
| 1 | 3 | 2 | M₀ = 2, M₁ = 1 | 1 |
| 2 | 3 | 3 | M₀ = 1, M₁ = 1, M₂ = 1 | 2 |
| 3 | 4 | 3 | M₀ = 2, M₁ = 1, M₂ = 1 | 3 |
| 4 | 5 | 3 | M₀ = 3, M₁ = 1, M₂ = 1 | 4 |
| 5 | 5 | 4 | M₀ = 2, M₁ = 1, M₂ = 1, M₃ = 1 | 5 |
| 6 | 6 | 3 | M₀ = 2, M₁ = 2, M₂ = 2 | 6 |
| 7 | 6 | 4 | M₀ = 2, M₁ = 2, M₂ = 1, M₃ = 1 | 7 |
| 8 | 7 | 2 | M₀ = 4, M₁ = 3 | 5 |
| 9 | 7 | 3 | M₀ = 3, M₁ = 3, M₂ = 1 | 7 |
| 10 | 7 | 4 | M₀ = 2, M₁ = 2, M₂ = 2, M₃ = 1 | 9 |
| 11 | 8 | 3 | M₀ = 3, M₁ = 3, M₂ = 2 | 9 |
| 12 | 8 | 4 | M₀ = 3, M₁ = 3, M₂ = 1, M₃ = 1 | 10 |

15. The wireless communication method of claim 1, wherein transmitting, to the second node, the at least one symbol corresponding to the at least one data bit comprises:
transmitting, to a second node, the at least one symbol corresponding to the at least one data bit by using a plurality of orthogonal frequency division multiplexing sub-carriers.

16-32. (canceled)

33. A first node, comprising:
a processor, configured to modulate at least one data bit to generate at least one symbol, wherein each symbol is one of a plurality of pulse-interval encoding (PIE) index modulation (IM) symbols, and
a communication unit, configured to transmit, to a second node, the at least one symbol corresponding to the at least one data bit,
wherein each PIE-IM symbol comprises a same plurality of PIE symbols,
wherein the PIE symbols have a plurality of different pulse widths.

34. The first node of claim 33, wherein the processor is further configured to perform the wireless communication method of claim 2.

35-36. (canceled)

37. A computer program product comprising a computer-readable program medium code stored thereupon, the code, when executed by a processor, causing the processor to implement a wireless communication method of claim 1.
